(19) United States
(12) Patent Application Publication
(10) Pub. No.: US 2013/0151284 A1
(43) Pub. Date: Jun. 13, 2013

(54) ASSIGNING CASES TO CASE EVALUATORS BASED ON DYNAMIC EVALUATOR PROFILES

(71) Applicants: Eric Cohen-Solal, Ossining, NY (US); Michael Lee, Arlington, MA (US)

(72) Inventors: Eric Cohen-Solal, Ossining, NY (US); Michael Lee, Arlington, MA (US)

(73) Assignee: KONINKLIJKE PHILIPS ELECTRONICS N.V., EINDHOVEN (NL)

(21) Appl. No.: 13/818,103

(22) PCT Filed: Aug. 15, 2011
(86) PCT No.: PCT/IB11/53606

§ 371 Date: Feb. 21, 2013

Related U.S. Application Data
(60) Provisional application No. 61/375,985, filed on Aug. 23, 2010.

(51) Int. Cl. G06F 19/00; G06Q 50/22

(52) U.S. Cl. CPC G06F 19/321; G06Q 50/22
USPC 705/2

(57) ABSTRACT

A method includes assigning, via a processor, cases to be evaluated by one or more case evaluators based on corresponding case profiles for the cases and a plurality of dynamic evaluator profiles for the one or more evaluators, wherein a dynamic evaluator profile for an evaluator includes information mined from a current set of case evaluation reports produced by the evaluator. A system includes a case profile repository (120) that stores case profiles for cases to be evaluated, a dynamic evaluator profile repository (112) that stores dynamic evaluator profiles for evaluators available to evaluate the cases, and a processor (102) that generates a signal indicative of an assignment of the cases to the evaluators based on the case profiles and the dynamic evaluator profiles.

The following generally relates to clinical informatics and more particularly to assigning cases to be evaluated to one or more case evaluators and is described with particular application to assigning images from imaging procedures for patients to radiologist evaluators for reading based at least on dynamic radiologist profiles for the radiologists. However, other types of cases and/or evaluators are also contemplated herein.

A Radiology Information System (RIS) is used by hospitals and imaging centers to optimize workflow and manage images and information circulation throughout the facility to deliver efficient patient care and services. This process includes a physician ordering a radiology procedure, the patient going to the radiology department, the imaging procedure being performed, and a radiologist reading the images and producing a report to be sent to the referring physician.

A RIS can also provide tools to manage resources for daily operations. By way of example, XIRIS, a product of Koninklijke Philips Electronics N.V., of the Netherlands, facilitates assigning patient cases to radiologists. With this product, the auto assign feature manages the radiologists' workflow and distributes patient load accordingly, which may result in having the most appropriate group of radiologists reading cases. XIRIS can also be useful when the RIS is integrated with the PACS (Picture Archiving and Communication System), which transmit patient information and images to workstations for interpreting and reviewing images.

Assigning a case to a radiologist can be done using a pre-defined “static” profile for the radiologists that includes general domain of expertise, availability, and preferences. However, there are limitations in defining an expertise only with the sub-specialty and even the modality and body part preferences. Consider a RIS that receives a computed tomography (CT) scan of the neck for an older female patient with suspected masses in the parotid. Under the current state-of-the-art, the RIS has the ability to send this scan to be read by the next available radiologist whose file identifies him or her as possessing specialized training in cervical CT.

Unfortunately, there is no means to identify the radiologists based on their experience in reading and assessing cases of parotid gland tumors in an elderly population. In this case, the radiology department may have several cervical CT specialists, but there may be one with the greatest experience in this particular area of expertise, and it may be desirable to have the option to send the patient images to this particular radiologist; however, the patient is simply assigned to the next available radiologist.

Aspects of the present application address the above-referenced matters, and others.

According to one aspect, a method includes assigning, via a processor, cases to be evaluated by one or more case evaluators based on corresponding case profiles for the cases and a plurality of dynamic evaluator profiles for the one or more evaluators, wherein a dynamic evaluator profile for an evaluator includes information mined from a current set of case evaluation reports produced by the evaluator.

According to another aspect, a system includes a case profile repository that stores case profiles for cases to be evaluated, a dynamic evaluator profile repository that stores dynamic evaluator profiles for evaluators available to evaluate the cases, and a processor that generates a signal indicative of an assignment of the cases to the evaluators based on the case profiles and the dynamic evaluator profiles.

According to another aspect, a computer readable storage medium encoded with instructions which, when executed by a processor of a computer, cause the processor to: assign imaging cases to be evaluated by one or more radiologists based on corresponding case profiles for patients and a plurality of dynamic radiologist profiles for the one or more radiologists, wherein a dynamic radiologist profile for a radiologist includes information mined from a current set of case evaluation reports produced by the radiologist.

The invention may take form in various components and arrangements of components, and in various steps and arrangements of steps. The drawings are only for purposes of illustrating the preferred embodiments and are not to be construed as limiting the invention.

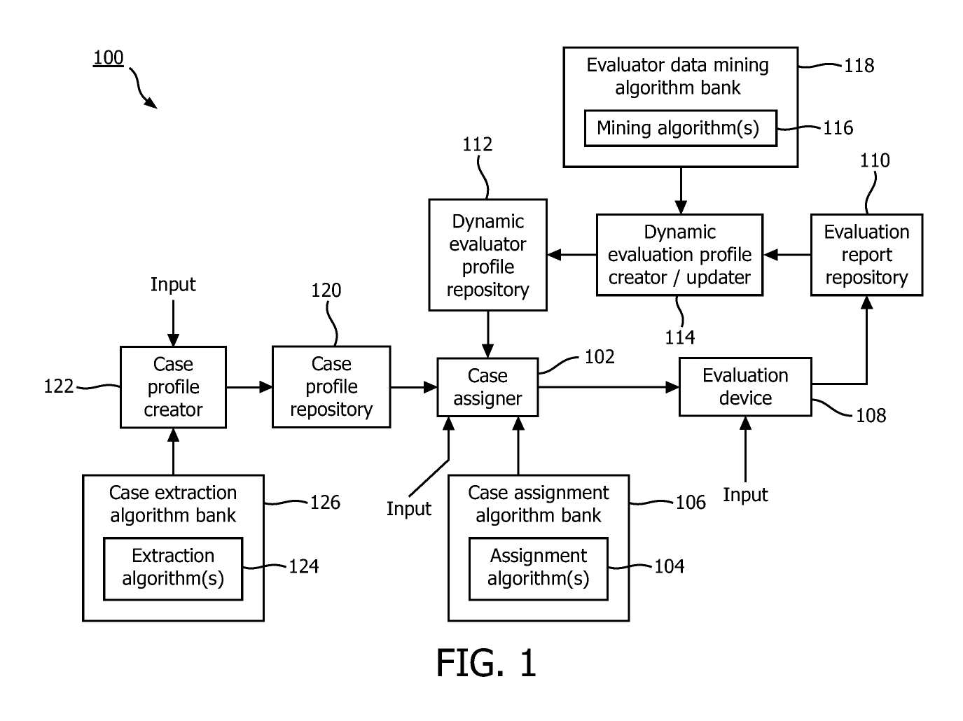

FIG. 1 illustrates an example case assigning system for assigning cases to be evaluated to one or more evaluators based on case profiles and dynamic evaluator profiles.

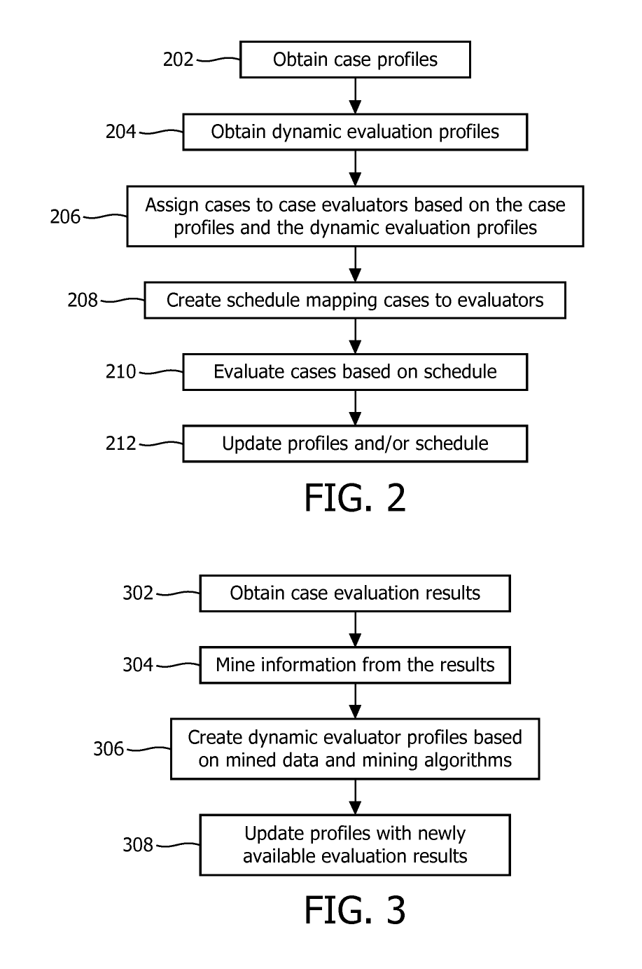

FIG. 2 illustrate a method for assigning cases to be evaluated to one or more evaluators based on case profiles and dynamic evaluator profiles.

FIG. 3 illustrates a method for creating and/or updating dynamic evaluator profiles.

FIG. 1 illustrates an example case assigning system 100. The system 100 includes a case assigner 102, which assigns cases to be evaluated to one or more case evaluators (e.g., a human or computing machine). In general, the case assigner 102 assigns cases to the one or more case evaluators based on one or more case assignment algorithms 104 in an algorithm bank 106, case profiles describing various aspects of the cases, and dynamic evaluator profiles describing various characteristics of the evaluators, which, generally, are dynamic in the sense that they are updated with evaluation results as such results become available. In other embodiments, other information may also be utilized to assign the cases to the case evaluators.

A case profile creator 122 is used to create case profiles stored based on the information about the cases (e.g., input by a human or machine) and one or more data extraction algorithms 124 in a case extraction algorithm bank 126. For example, for a current case, the case profile creator 122 may extract predetermined concepts from the data about cases and include such information in the case profiles. The case profile creator 122 may is for example a software module (i.e., a set of computer executable instructions) that is stored and executed on a computing device such as one or more processors, computers, workstations, or the like, with input and/or components to carry out the functions described herein. A case profile repository 120 stores the case profiles. The case profile repository 120 may comprise or include various storage medium such as one or more databases, servers, hard drives, etc. The case profile creator 122 and case profile repository 120 may be managed by a third party on third party computing systems or by the same party that manages the other software devices of system 100.

As described in greater detail below, case assigner 102 employs one or more algorithms 104 tailored towards specific evaluator characteristics such as evaluator actual experience, evaluator success rate (e.g., in terms of reaching positive finding), evaluator training level, evaluator skill set with respect to complementing a second evaluator assigned to evaluate the case, etc. Such algorithms can be default (e.g., “factory” set), shared (e.g., across facilities employing different systems 100), facility customized, and/or otherwise created. The particular algorithm(s) utilized for a particular case profile may be based on a default algorithm, a predetermined priority level, an input from a user or computing device, and/or otherwise. The case assigner 102 is a software module (i.e., a set of computer executable instructions) that is stored and executed on a computing device such as one or more processors, computers, workstations, or the like, with input and/or components to carry out the functions described herein.

The case assigner 102 outputs a signal indicative of a mapping between the cases and the case evaluators assigned to the cases. The case assigner 102 may update the signal (e.g., generate a new signal) based on any changes to the case profiles (e.g., an addition, a modification to, or deletion of a profile) and/or any changes to a dynamic evaluator profile (e.g., an addition, a modification to, or deletion of a profile). The update can be automatic in response to a change to the case and/or dynamic evaluator profiles or on-demand (e.g., in response to an input requesting an update) and/or periodically based on a predetermined update frequency. The update may occur before and/or during evaluation of the cases based on the mapping.

An evaluation device 108 receives the signal indicative of the case assignments. The evaluation device 108 visually presents the case assignments via the display and/or otherwise conveys (e.g., email, cell phone, page, text message, instant message, etc.) the assignments to appropriate personnel such as the evaluators, personnel responsible for scheduling the evaluators, etc. The signal may be presented in the form of a schedule or otherwise. The evaluation device 108 also allows the assignments to be manipulated (e.g., changing the evaluator) by authorized personnel. The evaluation device 108 may further allow an evaluator to review the case and create one or more electronic documents that include findings, comments, etc. The evaluation device 108 includes for example various computing devices such as one or more processors, computers, workstations, or the like, with various input components (e.g., a keyboard, a mouse, a touch screen, voice recognition, etc.), various output components (e.g., a display or monitor, a filmer, a printer, etc.), and software (i.e., computer executable instructions) which is executable to carry out various functions described herein. In this instance, the evaluation device 108 may be part of and/or interacts with one or more RIS and/or PACS systems.

An evaluation document repository 110 stores the evaluation results (e.g., evaluation reports) from the evaluations. The evaluation document repository 110 comprises or includes for example various storage medium such as one or more databases, servers, hard drives, or the like. Furthermore, the evaluation document repository 110 may be local to or remote from the system 100 and/or distributed amongst a plurality of systems. The evaluation document repository 110 may also comprise or include portable storage medium such as external hard drives, CDs, DVDs, memory sticks, or the like.

A dynamic evaluator profile creator/updater 114 creates and/or updates dynamic evaluator profiles based on the information in the evaluation report repository 110 and one or more data mining algorithms 116 in an evaluator data mining algorithm bank 118. As described in greater detail below in one example, the dynamic evaluator profile creator/updater 114 produces and provides a dynamic profile that represents the current available evaluations by the evaluators by updating the profile as evaluation results become available. As such, the dynamic evaluator profiles characterize the expertise of each individual evaluator through a statistical picture (or practice profile) of the types of cases the evaluator is dealing with everyday.

By way of non-limiting example, a dynamic evaluator profile may include information indicative of the different types of cases that an individual evaluator addresses each day, the number of each type of case, the complexity of the cases, the percentage of cases where the evaluator concluded positively based on the diagnosis, and/or other information. From this dynamic profile, it is possible to derive several functionalities corresponding to different associated goals. The dynamic evaluator profile creator/updater 114 is for example a software module (i.e., a set of computer executable instructions) that is stored and executed on a computing device such as one or more processors, computers, workstations, or the like, with input and/or components.

A dynamic evaluator profile repository 112 stores the dynamic evaluator profiles. As noted above, the profiles are dynamic in the sense that they can be updated in response to a newly created and/or modified electronic document being received at the evaluation repository 110. The dynamic evaluator profile repository 112 may include various storage medium as described above in connection with the evaluation document repository 110.

One or more of the elements shown in FIG. 1 may be stored, used, accessed, and/or executed on the same or different computing device, and in some cases on the same computing device in various combinations.

FIG. 2 illustrates a method for assigning cases to case evaluators based on case profiles and dynamic evaluator profiles. It is to be appreciated that the ordering of the following acts is not limiting. As such, in other embodiments, the ordering may be different. Furthermore, in other embodiment, additional acts may be added and/or one or more of the acts may be omitted.

For explanatory purposes, the method is described in connection with a medical informatics system such as a system that can be employed in connection with one or more imaging departments of a healthcare facility. However, it is to be understood that the embodiments herein are also amenable to any system in which a goal, task, or the like to be completed is to be assigned to a human and/or machine that completes the goal, task, etc.

At 202, a plurality of case profiles for a plurality of cases is obtained. As described herein, the case profiles can be obtained from the case profile repository 120. Case profiles can also be obtained from other sources. In this example, the case profiles are for patients to be examined, and the information in the case profiles may be obtained from a prescription ordering an imaging procedure, patient medical and/or imaging history, the reason for the imaging procedure (e.g., screening, diagnostic, post-therapy, etc) and/or other patient information.

At 204, a plurality of dynamic evaluator profiles for a plurality of evaluators is obtained. In this example, the plurality of evaluators includes the radiologists available to read the images from the imaging procedures. The information in the profiles may include information mined from and related to the imaging reports generated by the radiologists. As described herein, the dynamic evaluator profiles can be obtained from the dynamic evaluator profile repository 112. Dynamic evaluator profiles can also be obtained from other sources.

At 206, the patient cases are assigned to the radiologist evaluators based on the plurality of case profiles and the plurality of dynamic evaluator profiles. As described herein, the cases are assigned to the evaluators based on one or more assignment algorithms 104 in the case assignment algorithms bank 106. Case assignment algorithms can also be obtained from other sources. As described in greater detail below, suitable algorithms may be directed towards current radiologist actual experience, radiologist success with reaching positive diagnostic finding, radiologist training level, radiologist skill set with respect to complementing a second radiologist assigned to evaluate the case, etc.

At 208, an electronic schedule mapping the cases to the assigned radiologist is created.

At 210, the radiologists evaluate the resulting images based on the schedule.

At 212, the case profiles, the dynamic evaluator profiles, and/or the schedule are modified, if needed, before and/or during evaluation of the cases.

For example, the addition of a patient case (e.g. emergency case needing urgent radiologist's attention) may result in creation of a new case profile, which is provided to the case assigner 102, which assigns the new case to a radiologist (which may result in a change in a case assignment in the schedule) before and/or during implementation of schedule, and the radiologists evaluate or continue to evaluate the cases based on the updated schedule. The change in the case profile may additionally or alternatively be a result of deletion of a case profile and/or modification of a case profile.

In another example, a radiologist's profile may change based on the results of a completed evaluation pursuant to the schedule that has become available to the dynamic evaluator profile creator/updater 114. The updated dynamic evaluator profile is provided to the case assigner 102, which may re-assign one or more cases to be evaluated based on the updated dynamic evaluator profile before and/or during implementation of schedule, and the radiologists evaluate the cases based on the updated schedule. The change in the profile may additionally or alternatively be a result of the availability of an evaluator.

FIG. 3 illustrates a method for creating and/or updating dynamic evaluator profiles. It is to be appreciated that the ordering of the following acts is not limiting. As such, in other embodiments, the ordering may be different. Furthermore, in other embodiment, additional acts may be added and/or one or more of the acts may be omitted.

Again, for explanatory purposes, this method is described in connection with a medical informatics system such as a system that can be employed in connection with one or more imaging departments of a healthcare facility. However, it is to be understood that the embodiments herein are also amenable to any system in which a goal, task, or the like to be completed is to be assigned to a human and/or machine that completes the goal, task, etc.

At 302, image evaluation reports and/or other documents created and/or modified by radiologists in response to evaluating images are obtained. Such information may be in electronic format and obtained from the evaluation report repository 110, which may be part of one or more RIS, HIS, PACS, etc. systems, and/or one or more other systems. This information may include the clinical history of patients (e.g., body location(s), symptoms, signs, reason(s) for the exam, prior knowledge, etc.) and/or the radiologist's findings, relevant anatomy locations and/or conclusions with current diagnosis for the patient. Such information may be included in a structured format (e.g., an electronic form) and/or less structured electronic documents containing free text.

At 304, information about the radiologists is mined from evaluation reports and/or other documents based on one or more of the data mining algorithms 116 in the evaluator data mining algorithm bank 118. In one instance, a data mining algorithm includes mining for information related to the clinical history of the patients, the radiologist's findings, the relevant anatomy locations and/or conclusions with current diagnosis for the patients, etc. For mining free text, natural language processing (NLP) techniques can be used to automatically locate and identify relevant pieces of information.

At 306, dynamic evaluator profiles are generated based on the mined information. Generally, a dynamic evaluator profile represents all the cases that the radiologist has worked on so far, and may include various information about the cases. By way of non-limiting example, in one instance, for one or more pre-determined medical terms of interest, all the reports for the radiologist containing a particular concept can be counted, and the number of times the terms are in the reports can be included in the profile for the radiologist.

In another example, for any combination of pre-determined terms of interest found in a report, all the reports containing the same combination of terms can be counted, and this information can be included in the profile for the radiologist. A result of such a profile is a picture of all the clinical history medical concepts encountered by an individual radiologist and the associated statistics. Moreover, for combination of terms, the medical concepts associated with the findings and conclusion sections may also be included in a profile.

Other information that may be included in the profile is how long ago and how much time a radiologist took to read a case, and whether or not the radiologist reported a positive finding in that case. With a system in which a radiologist is able to store some cases in personal case repositories (“personal folders”), such cases may provide information related to research, teaching, or clinical grand rounds, or other information of particular interest to the radiologist.

In one embodiment, a weighting scheme is applied so that aged reports are given less weight and newer reports are given higher weight, which may facilitate tailoring profiles based on the more recently generated reports. Additionally or alternatively, a weighting scheme can be applied to the reports with positive findings to emphasize such cases. Additionally or alternatively, a weighting scheme can be applied to the reports in the “personal folders” as such cases may be of more interest to the radiologist.

At 308, the dynamic evaluator profiles are dynamically updated to reflect the current available evaluation reports such as evaluation reports that have become available since creation of the dynamic evaluator profile or the last update to the dynamic evaluator profile. Such profiles provide a dynamic description of a radiologist's actual practice define and current expertise, which may facilitate more accurately assigning cases to evaluators, relative to non-dynamic profiles.

The following provides some non-limiting examples of case assignment algorithms employed by the case assigner 102.

One suitable case assignment algorithm assigns patient cases based on actual experience. Whereas a static profile may not represent the current expertise of the radiologist and/or a current account of the number and types of cases concretely addressed during a physician's daily practice, the dynamic profile provides greater and more recent information as the types of cases coming daily to a radiology department change day by day.

With this algorithm, the case profile is compared to each dynamic evaluation profile to select the radiologists who has evaluated similar cases in the past and the frequency of evaluating such cases. As a result, a list of radiologists may be sorted by the amount of relevant experience they have for any given case. A particular radiology center may have for example 120 patients to be seen and 6 radiologists to be assigned these cases. For each case, the top of the list gets the case. If a radiologist reaches his quota for the day, the second most relevant radiologist gets the next case, etc.

In another example, a referring physician may suspect a specific problem and mention a possible diagnosis to be confirmed or rejected. From the profiles, it is possible to extract a sub-set of physicians having cases with a similar patient history as well as having concluded positively or negatively on the suspected diagnosis (from referring physician). This list can be sorted based on frequency of cases (count) or otherwise.

Another case assignment algorithm assigns more difficult or rare case directly to a radiologist with a higher likelihood in arriving to the right diagnosis. For example, there may be cases where reports from a referring physician, previous radiology reports from a different radiology center, or the characteristics of the case itself suggest that the present case is more complicated than a typical case.

This case can be assigned to a radiologist who has greatest experience specifically on prior cases with similar clinical history and a high rate of reaching a positive diagnostic finding on these cases. In this situation, a case may be considered complicated, rare or difficult if, for example, the patient had previous exams that were inconclusive and led to try a different type of imaging exam.

The referring physician or the previous colleague radiologist might suspect one or more problems that would be contained in the history section. This situation can happen when for example a community hospital does not see very often this kind of cases and refers the case to a specialized or larger center. As in the previous case, the evaluator profiles indicate which radiologists have both seen similar clinical histories as well as the suspected diagnosis.

Another case assignment algorithm assigns unseen types of cases to a radiologist to increase his expertise. This can be considered a form of continuous medical education where a doctor is assigned a case based on the fact that his record does not show any cases seen in the last six months for example. A goal is to train the radiologist on a more diversified spectrum of cases. This can be considered for more junior radiologists along with the supervision of a senior radiologist or in the context of a peer review to guarantee quality as well as necessary training.

In this situation, cases dealt with by the radiology department can be compared with a dynamic evaluator profiles to identify the “holes” in the radiologist current exposure to a spectrum of important cases. These holes can be identified and organized by categories (body locations, symptoms, associated diagnosis) and randomly or not automatically assign cases to this radiologist. This can be done in the context of a peer review or a mentor program with the correct supervision.

Another case assignment algorithm assigns a case to two (or more) radiologists for optimized double-reading. In some types of examinations (mammography, for example), cases are typically read by two radiologists to ensure a high confidence in the accuracy of the combined result. Rather than assigning randomly, it is possible to assign the case to radiologists who in some way differ in the types of findings they report on.

By exploiting this difference of opinion, it may be possible to improve diagnostic accuracy. With the algorithm, two profiles that are dissimilar based on their prior experience can be selected. Evaluated profiles can be compared on the types of cases they have read or the terminologies they report on. Instead of assigning to a single radiologist, two or more radiologists can be selected, factoring in the dissimilarities.

Other case assignment algorithms may also be used. Further, one of the above discussed algorithms or another algorithm may be a default algorithm. In another instance, the algorithm employed may be selected based on the case profile. In another instance, authorized personnel select the algorithm to be used for a particular case. In another instance, multiple algorithms are employed to assign cases.

Static (non-dynamic) profiles may be utilized in connection with dynamic evaluation profiles by the case assigner 102 to assign cases to be evaluated to evaluators for evaluation.

Again, FIGS. 2 and 3 are described in the context of patient imaging procedures and assigning radiologist to evaluate the images form the imaging procedure. However, it is to be understood that the cases may represents general goals, tasks, or the like to be evaluated and/or completed by one or more evaluators, and the evaluators may represent human and/or machines that can evaluate and/or complete the goals, tasks, or the like.

The above may be implemented by way of computer readable instructions, which when executed by a computer processor(s), cause the processor(s) to carry out the described techniques. In such a case, the instructions are stored in a computer readable storage medium associated with or otherwise accessible to the relevant computer or in computer readable signal medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
assigning, via a processor, cases to be evaluated by one or more case evaluators based on corresponding case profiles for the cases and a plurality of dynamic evaluator profiles for the one or more evaluators, wherein a dynamic evaluator profile for an evaluator includes information mined from a current set of case evaluation reports produced by the evaluator.

2. The method of claim 2, wherein the cases include images and the one or more evaluator are radiologists.

3. The method of claim 1, further comprising:
updating the case assignment in response to at least one of a change in the case profiles or a change in a dynamic evaluator profile.

4. The method of claim 1, further comprising:
updating a dynamic evaluator profile for an evaluator in response to a case evaluation report produced by the evaluator becoming available for mining.

5. The method of claim 1, wherein the cases are assigned based on evaluator actual experience.

6. The method of claim 1, wherein the cases are assigned based on a success rate of the evaluator reaching positive finding.

7. The method claim 1, wherein the cases are assigned based on evaluator training experience.

8. The method of claim 1, wherein the cases are assigned more than one evaluator based on evaluator complementary skill sets.

9. The method of claim 1, further comprising:
assigning a case to an evaluator based on a pre-defined static profile that represents at least one of evaluator general domain of expertise, availability, or preferences.

10. The method of claim 1, wherein the dynamic evaluator profiles provide a statistical picture of types of cases an evaluator evaluates day to day.

11. The method of claim 1, further comprising:
generating an electronic schedule based on the case assignment, wherein the schedule is employed by the evaluators to evaluate the cases.

12. A system, comprising:
a case profile repository (120) that stores case profiles for cases to be evaluated;
a dynamic evaluator profile repository (112) that stores dynamic evaluator profiles for evaluators available to evaluate the cases; and
a processor (102) that generates a signal indicative of an assignment of the cases to the evaluators based on the case profiles and the dynamic evaluator profiles.

13. The system of claim 12, wherein the cases include images and the one or more evaluator are radiologists.

14. The system of claim 12, further comprising:
updating a dynamic evaluator profile for an evaluator with results of an evaluation report produced by the evaluator when the results become available for mining.

15. The system of claim 14, further comprising:
updating the signal in response to an update to the dynamic evaluator profile.

16. The system of claim 12, further comprising:
an evaluation device (108) that presents the assignment, based on the signal, in human readable format.

17. The system of claim 12, wherein the signal represents an electronic schedule.

18. The system of claim 12, wherein the cases are assigned based on one or more of:
evaluator actual experience; a success rate of the evaluator reaching positive finding; evaluator training experience; or
evaluator complementary skill sets.

19. The system of any of claim 12 wherein the system is part of a medical informatics system.

20. A computer readable storage medium encoded with instructions that when executed by a processor causes the processor to:
assign imaging cases to be evaluated by one or more radiologist based on corresponding case profiles for patients and a plurality of dynamic radiologist profiles for the one or more radiologists, wherein a dynamic radiologist profile for a radiologist includes information mined from a current set of case evaluation reports produced by the radiologist.
